(19) United States
(12) Patent Application Publication
(10) Pub. No.: US 2010/0129040 A1
(43) Pub. Date: May 27, 2010

(54) System Comprising a Plurality of Optical Waveguide Distribution Devices

(76) Inventors: Bert Zamzow, Stockdorf (DE); Michael Müller, Menden (DE); Franz-Friedrich Fröhlich, Hagen (DE)

Correspondence Address: CORNING INCORPORATED, INTELLECTUAL PROPERTY DEPARTMENT, SP-TI-3-1, CORNING, NY, 14831, US

(21) Appl. No.: 12/697,628

(22) Filed: Feb. 1, 2010

Related U.S. Application Data
(63) Continuation of application No. PCT/EP2008/005755, filed on Jan. 14, 2008.

(30) Foreign Application Priority Data
Jul. 31, 2007 (DE) 202007010780.3

(51) Int. Cl. G02B 6/00

(52) U.S. Cl. 385/135

(57) ABSTRACT

The system comprising a plurality of optical waveguide distribution devices has a first number of logic groups of optical waveguide distribution devices, each logic group comprising a second number of optical waveguide distribution devices, wherein: a) in order to ensure structured wiring of fiberoptic modules within a logic group comprising optical waveguide distribution devices, only two lengths of prefabricated patch cables are kept ready, namely a first length designed for wiring fiberoptic modules within an optical waveguide distribution device and a second length designed for wiring fiberoptic modules between optical waveguide distribution devices which are spaced at a maximum distance apart from one another within the respective logic group, it being possible, when wiring of fiberoptic modules between optical waveguide distribution devices which are not spaced at a maximum distance apart from one another within the respective logic group needs to be carried out, for the corresponding excess length of the patch cable designed for the maximum distance to be stored in the respective target optical waveguide distribution device on an excess length storage device of the target optical waveguide distribution device; b) in order to ensure structured wiring of fiberoptic modules of two different logic groups comprising optical waveguide distribution devices, a length of prefabricated patch cables is kept ready which is designed for wiring fiberoptic modules of optical waveguide distribution devices which are spaced at a maximum distance apart from one another in the two logic groups, it being possible, when wiring of fiberoptic modules of optical waveguide distribution devices which are not spaced at a maximum distance apart from one another in the two logic groups needs to be carried out, for the corresponding excess length of the patch cable designed for the maximum distance to be stored in the respective target optical waveguide distribution device on an excess length storage device of the target optical waveguide distribution device.

### RELATED APPLICATIONS

This application is a Continuation of International Application No. PCT/EP08/005,755 filed Jul. 14, 2008, which claims priority to German Application No. 202007010780.3 filed Jul. 31, 2007, both applications being incorporated herein by reference.

### TECHNICAL FIELD

The technology of the disclosure relates to a system comprising a plurality of optical waveguide distribution devices.

### BACKGROUND

When constructing fiberoptic cable networks, optical waveguide distribution devices are required for ensuring structured wiring. The product catalogue “Zubehör für LWL-Kabelnetze” [Accessories for fiberoptic cable networks], edition 1, Corning Cable Systems, page 150, year 2001, has disclosed an optical waveguide distribution device in the form of a distribution cabinet, in which withdrawable parts in the form of module carriers are found. Fiberoptic modules are positioned in the module carriers, between whichstructured wiring via patch cables which are prefabricated with optical waveguide jacks on both sides is provided.

When a large number of fiberoptic modules are required for constructing a fiberoptic cable network, these modules are positioned in a large number of optical waveguide distribution devices, which then form a system comprising a plurality of optical waveguide distribution devices. In this case, on the one hand structured wiring of fiberoptic assemblies within an optical waveguide distribution device and on the other hand structured wiring of fiberoptic modules of different optical waveguide distribution devices are necessary.

Two basic procedures are known from the art for providing such structured wiring in a system comprising a plurality of optical waveguide distribution devices. In a first procedure, a precisely defined length of a patch cable is provided for each wiring between two fiberoptic modules, with the result that no excess lengths are produced within the system comprising a plurality of optical waveguide distribution devices. For this purpose, a large number of patch cables of different lengths need to be available. In accordance with a second procedure, only a single length of a patch cable is provided, with this length being designed for the maximum distance between the fiberoptic modules to be wired, in which case excess lengths of different lengths are produced in the system which need to be handled correspondingly. In this case, the handling of the excess lengths presents difficulties, with the result that, under certain circumstances, optical waveguide distribution devices need to be provided which do not accommodate any fiberoptic modules but only excess lengths. Against this background, the embodiments in the disclosure is based on the problem of providing a system comprising a plurality of optical waveguide distribution devices with structured wiring.

The system comprising a plurality of optical waveguide distribution devices has a first number of logic groups of optical waveguide distribution devices, each logic group comprising a second number of optical waveguide distribution devices, wherein: a) in order to provide structured wiring of fiberoptic modules within a logic group comprising optical waveguide distribution devices, two lengths of prefabricated patch cables are provided, namely a first length designed for wiring fiberoptic modules within an optical waveguide distribution device and a second length designed for wiring fiberoptic modules between optical waveguide distribution devices which are spaced at a maximum distance apart from one another within the respective logic group, it being possible, when wiring of fiberoptic modules between optical waveguide distribution devices which are not spaced at a maximum distance apart from one another within the respective logic group needs to be carried out, for the corresponding excess length of the patch cable designed for the maximum distance to be stored in the respective target optical waveguide distribution device on an excess length storage device of the target optical waveguide distribution device; b) in order to ensure structured wiring of fiberoptic modules of two different logic groups comprising optical waveguide distribution devices, a length of prefabricated patch cables is kept ready which is designed for wiring fiberoptic modules of optical waveguide distribution devices which are spaced at a maximum distance apart from one another in the two logic groups, it being possible, when wiring of fiberoptic modules of optical waveguide distribution devices which are not spaced at a maximum distance apart from one another in the two logic groups needs to be carried out, for the corresponding excess length of the patch cable designed for the maximum distance to be stored in the respective target optical waveguide distribution device on an excess length storage device of the target optical waveguide distribution device.

The system comprising a plurality of optical waveguide distribution devices enables structured wiring between fiberoptic modules which, given a defined combination of different lengths of patch cables and corresponding excess length storage devices within the optical waveguide distribution devices, can be scaled as desired and allows for subsequent intervention in the wiring and corresponding changes thereto with little complexity. Furthermore, even when there is a large number of optical waveguide distribution devices, no optical waveguide distribution devices are required within the system which are only used for handling excess lengths.

### BRIEF DESCRIPTION OF THE DRAWINGS

Exemplary embodiments will be explained in more detail with reference to the drawing, in which:

FIG. 1 shows a schematized illustration of a system according to an exemplary embodiment comprising a plurality of optical waveguide distribution devices;

FIG. 2 shows an optical waveguide distribution device of the system according to an exemplary embodiment in a front view with pivoted-in pivoting frame; and

FIG. 3 shows an optical waveguide distribution device of the system according to and exemplary embodiment in a side view with a pivoted-out pivoting frame.

### DETAILED DESCRIPTION

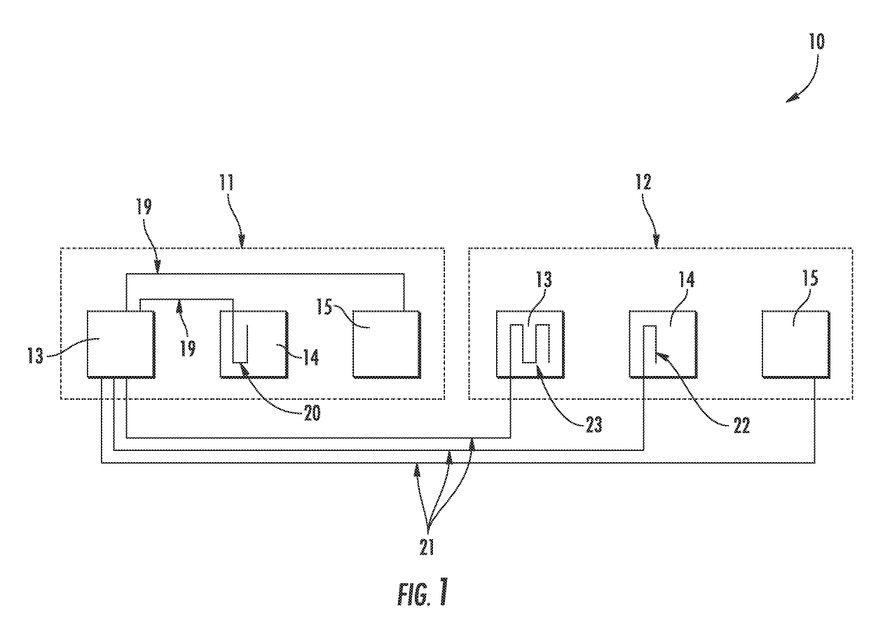

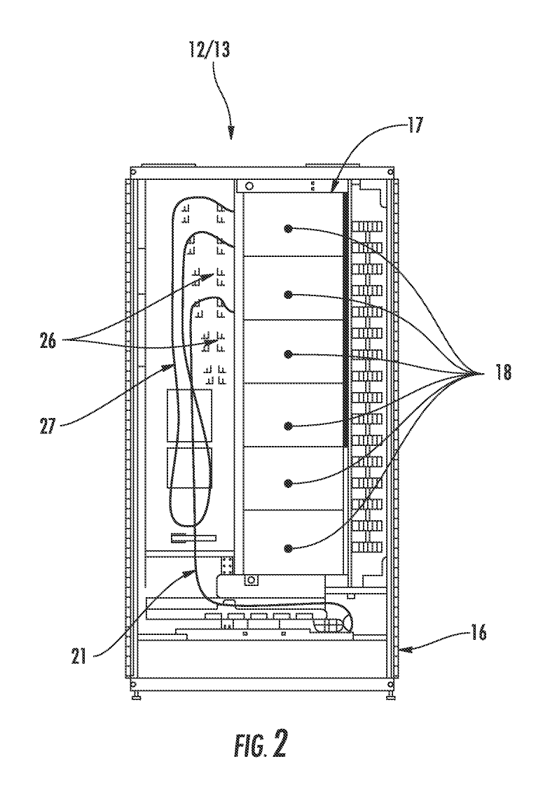

FIG. 1 shows a schematized illustration of a system comprising a plurality of optical waveguide distribution devices, wherein, in the exemplary embodiment in FIG. 2, the system 10 comprises two logic groups 11, 12 comprising in each case three optical waveguide distribution devices 13, 14 and 15. The optical waveguide distribution devices 13, 14 and 15 are so-called optical waveguide distribution cabinets, each optical waveguide distribution cabinet conventionally accommodating a plurality of module carriers, each module carrier accommodating a plurality of fiberoptic modules, between which structured wiring via patch cables is to be provided within the system. Patch cables are fiberoptic cables which have been prefabricated with optical waveguide jacks on both ends.

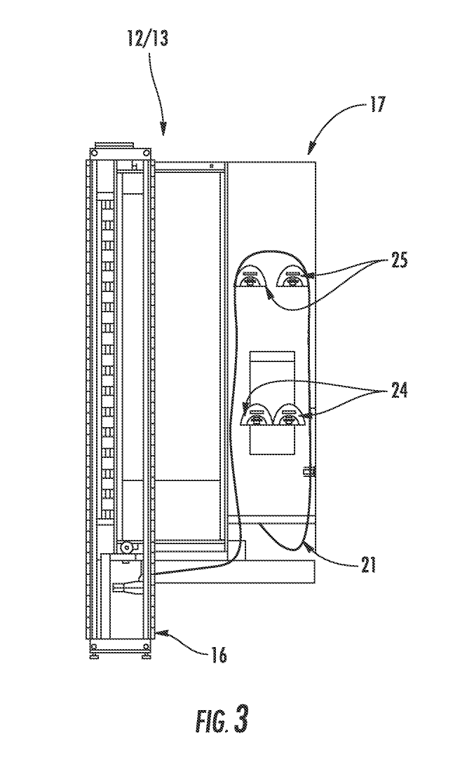

FIGS. 2 and 3 show an optical waveguide distribution device 13 or 14 or 15 in the form of an optical waveguide distribution cabinet of a logic group 11 or 12 of the system illustrated on its own, with such an optical waveguide distribution device comprising a pivoting frame 17, which is mounted pivotably in a housing or rack 16 and accommodates module carriers 18 with fiberoptic modules.

As has already been mentioned, in the exemplary embodiment shown in FIG. 1, the system n comprises a plurality of optical waveguide distribution devices comprising two logic groups 11, 12 of optical waveguide distribution devices, each of the two logic groups 11, 12 comprising three optical waveguide distribution devices 13, 14 and 15. Even at this juncture reference is made to the fact that the number of logic groups of optical waveguide distribution devices and the number of optical waveguide distribution devices per logic group can be any number as desired, without restriction.

In order to provide for structured wiring between fiberoptic modules within each logic group 11, 12 comprising optical waveguide distribution devices, only two lengths of prefabricated patch cables are necessary. A first length, which is not illustrated in FIG. 1, is designed for wiring fiberoptic modules within an optical waveguide distribution device 13 or 14 or 15. A second length is designed for wiring fiberoptic modules between optical waveguide distribution devices which are spaced at a maximum distance apart from one another within the respective logic group 11, 12. In the exemplary embodiment in FIG. 1 these are the optical waveguide distribution devices 13, 15. FIG. 1 shows a patch cable 19, which has the second length, i.e. is designed for wiring fiberoptic modules between the optical waveguide distribution devices 13, 15 which are spaced at a maximum distance apart from one another within the respective logic group 11, 12. If wiring takes place using this patch cable 19 between the fiberoptic modules of the optical waveguide distribution devices 13, 15, no excess lengths need to be handled.

Such a patch cable with the second length which is designed for optical waveguide distribution devices which are spaced at a maximum distance apart from one another within a logic group is also used when wiring between optical waveguide distribution devices which are not spaced at a maximum distance apart from one another within the respective logic group is to be carried out, i.e. in FIG. 1, for example, between the optical waveguide distribution devices 13, 14 of the logic group 11.

In this case, the corresponding excess length 20 of the patch cable 19 designed for the maximum distance is handled or stored in the respective target optical waveguide distribution device, in the exemplary embodiment shown in FIG. 1 in the optical waveguide distribution device 14, on an excess length storage device of the target optical waveguide distribution device. This excess length to be handled is a defined excess length, which corresponds to the difference in distance between the maximum distance within the logic group and the distance from the respective target optical waveguide distribution device.

If, accordingly, a logic group of optical waveguide distribution devices has a number N of optical waveguide distribution devices, only two lengths of prefabricated patch cables are necessary for the structured wiring of fiberoptic modules within the respective logic group. A first length is used for wiring fiberoptic modules within an optical waveguide distribution device. A second length is used for wiring fiberoptic modules of different optical waveguide distribution devices within the logic group, the second length being designed for the maximum distance between optical waveguide distribution devices within the respective logic group.

Patch cables with this second length are also used when wiring of fiberoptic modules between two optical waveguide distribution devices which are not spaced at a maximum distance apart from one another within the respective logic group is necessary, in which case the corresponding excess length of the patch cable with the second length needs to be handled in the target cabinet. Each optical waveguide distribution device has a number N−1 of excess length storage devices for storing excess lengths with defined different lengths.

In order to provide for structured wiring of fiberoptic modules of two different logic groups comprising optical waveguide distribution devices, only one length of prefabricated patch cables is kept ready, this length being designed for wiring fiberoptic modules which are spaced at a maximum distance apart from one another in the two logic groups.

In the exemplary embodiment shown, this length of a patch cable is designed for the maximum distance between the optical waveguide distribution device 13 of the logic group 11 and the optical waveguide distribution device 15 of the logic group 12, with no excess length being produced when a corresponding patch cable 21 for wiring fiberoptic modules between the optical waveguide distribution devices which are spaced at a maximum distance apart from one another of the two logic groups is used.

As shown in FIG. 1 even when wiring of fiberoptic modules between optical waveguide distribution devices which are not spaced at a maximum distance apart from one another within the two logic groups 11, 12 is necessary, a patch cable 21 with the length designed for the maximum distance is used, in which case corresponding, defined excess lengths are produced which are stored or handled in the respective target optical waveguide distribution device. The excess lengths produced in the process correspond to the excess lengths which can be produced when wiring fiberoptic modules within a logic group.

For example, FIG. 1 shows that, when the patch cable 21, whose length is designed for the maximum distance between the optical waveguide distribution device 13 of the logic group 11 and the optical waveguide distribution device 15 of the logic group 12, is used for wiring between the optical waveguide distribution device 13 of the logic group 11 and the optical waveguide distribution device 14 of the logic group 12, a single excess length 22 needs to be handled.

If such a patch cable 21 is used for wiring between the optical waveguide distribution device 13 of the logic group 11 and the optical waveguide distribution device 13 of the logic group 12, a double excess length 23 needs to be handled in the optical waveguide distribution device 13 of the logic group 12, which in this case is the target optical waveguide distribution device. In the above way, it is possible for the system to be extended by further logic groups of optical waveguide distribution devices.

When each logic group comprises a number N of, for example 3, optical waveguide distribution devices, at most only N−1, or 2, different excess lengths need to be handled, in particular either a single excess length or a double excess length in FIG. 1. In the corresponding target optical waveguide distribution device, corresponding excess length storage devices are provided for each excess length. When the system comprises a number M of logic groups having in each case N optical waveguide distribution devices, at most a number M+1 of prefabricated patch cables with defined different lengths and, depending on the optical waveguide distribution devices, at most excess length storage devices for N−1 excess lengths which are different in a defined manner are necessary.

As shown in FIG. 3, which shows a side view of an optical waveguide distribution device with a pivoting frame 17 which has been pivoted out of said distribution device, excess length devices 24, 25 for handling the excess lengths which are produced when constructing wiring with the aid of the patch cables 19, 21 between different optical waveguide distribution cabinets are associated with a rear side of the pivoting frame 17. The excess length stores 24 serve the purpose of handling a single excess length, and the excess length storage devices 25 are used for handling a double excess length. The optical waveguide distribution device illustrated in FIG. 3 is accordingly the optical waveguide distribution device 13 of the logic group 12.

FIG. 2 shows a front view of the optical waveguide distribution device 13 with the pivoting frame 17 pivoted in and accordingly a front view of the pivoting frame 17. FIG. 2 shows that excess length storage devices 26 are associated with a front side of the pivoting frame, which excess length storage devices 26 are used for handling excess lengths if fiberoptic modules within an optical waveguide distribution device 13 are to be wired with the aid of a patch cable 27 of the first length.

1. A fiber optic system, comprising:
a first optical waveguide distribution device;
a plurality of second optical waveguide distribution devices wherein each of the plurality of second optical waveguide distribution devices is located at a respective distance from the first optical waveguide distribution device;
a first length of prefabricated patch cable, wherein prefabricated patch cables each having the first length are used to wire between fiber optic modules in the first optical waveguide distribution device;
a second length of prefabricated patch cable, wherein prefabricated patch cables each having the second length are used to wire between the fiber optic modules in the first optical waveguide distribution device and respective fiber optic modules in different ones of the plurality of second optical waveguide distribution devices, and wherein the second length of prefabricated patch cable is designed to extend from the first optical waveguide distribution device to the one of the plurality of second optical waveguide distribution devices located at the maximum distance in the system from the first optical waveguide distribution device; and
an excess length storage device located in at least one of the plurality of second optical waveguide distribution devices, wherein excess length of the prefabricated patch cable having the second length of prefabricated patch cable is stored.

2. The system of claim 1, wherein the plurality of second optical waveguide distribution devices comprises a N number of second optical waveguide distribution devices.

3. The system of claim 2, wherein a N−1 number of second optical waveguide distribution devices each comprise an excess length storage device for storing excess lengths of the prefabricated patch cable of the second length.

4. The system of claim 1, wherein the first optical waveguide distribution device and the plurality of second optical waveguide distribution devices are within a first logic group.

5. The system of claim 1, wherein the first optical waveguide distribution device is within a first logic group and the plurality of second optical waveguide distribution devices are within a second logic group.

6. The system of claim 1, wherein the first optical waveguide distribution device and a first number of the plurality of second optical waveguide devices are within a first logic group, and a second number of the plurality of second optical waveguide distribution devices are within a second logic group.

7. A fiber optic system, comprising:
a first logic group comprising,
a first optical waveguide distribution device;
a plurality of second optical waveguide distribution devices wherein each of the plurality of second optical waveguide distribution devices is located at a respective distance from the first optical waveguide distribution device;
a first length of prefabricated patch cable, wherein prefabricated patch cables each having the first length are used to wire between fiber optic modules in the first optical waveguide distribution device;
a second length of prefabricated patch cable, wherein prefabricated patch cables each having the second length are used to wire between the fiber optic modules in the first optical waveguide distribution device and respective fiber optic modules in different ones of the plurality of second optical waveguide distribution devices, and wherein the second length of prefabricated patch cable is designed to extend from the first optical waveguide distribution device to the one of the plurality of second optical waveguide distribution devices located the maximum distance in the first logic group from the first optical waveguide distribution device;
a first excess length storage device located in at least one of the plurality of second optical waveguide distribution devices, wherein excess length of the prefabricated patch cable having the second length of prefabricated patch cable is stored;
a second logic group, comprising a plurality of third optical waveguide distribution devices;
a third length of prefabricated patch cable, wherein prefabricated patch cables each having the third length are used to wire between the fiber optic modules in the first optical waveguide distribution device and respective fiber optic modules in different ones of the plurality of third optical waveguide distribution devices, and wherein the third length of prefabricated patch cable is designed to extend from the first optical waveguide distribution device to the one of the plurality of third optical waveguide distribution devices located the maximum distance in the system from the first optical waveguide distribution device; and
a second excess length storage device located in at least one of the plurality of third optical waveguide distribution devices, wherein excess length of the prefabricated patch cable having the third length of prefabricated patch cable is stored.

8. The system claim 7, further comprising an M number of logic groups of optical waveguide distribution devices, wherein the first logic group and the second logic group are included in the M number of logic groups.

9. The system of claim 8, wherein a maximum of M+1 prefabricated patch cables of different lengths is necessary to wire kept ready.
